(19) United States
(12) Patent Application Publication
(10) Pub. No.: US 2013/0085965 A1
(43) Pub. Date: Apr. 4, 2013

(54) Method and Apparatus of Investment Strategy Formulation and Evaluation

(71) Applicant: Hui Dai, Redmond, WA (US)

(72) Inventor: Hui Dai, Redmond, WA (US)

(21) Appl. No.: 13/612,183

(22) Filed: Sep. 12, 2012

Related U.S. Application Data
(60) Provisional application No. 61/543,042, filed on Oct. 4, 2011.

(51) Int. Cl. G06Q 40/06

(52) U.S. Cl. 705/36 R

(57) ABSTRACT

A technique for formulating and evaluating financial investment strategies is provided. In one aspect, a method based on the technique receives, on an input device, a first user input from a user; receives financial data from a data collecting service and a data mining service; stores the received data; computes to provide a user-specific investment strategy based at least on the first user input, a user profile of the user, a trading style of the user, and the received data; and displays to the user, on an output device, the user-specific investment strategy.

### CROSS-REFERENCE TO RELATED APPLICATIONS

This application claims the priority benefit of U.S. Patent Application No. 61/543,042, filed on Oct. 4, 2011, the entirety of which is hereby incorporated by reference.

### BACKGROUND

1. Technical Field

The present disclosure relates to techniques for formulating and evaluating investment strategies for investing in a plurality of financial products. More specifically, the present disclosure relates to methods and apparatus that utilize interactive user interface in the formulation and evaluation of financial investment strategies.

2. Description of Related Art

Presently there exist a variety of software tools and products that aid an investor, e.g., an investment professional, in activities involved with financial markets, such as stock charting software and back testing software, etc. However, most of the existing financial investment software tools and products require the user to be able to program with some sort of computer software programming language, and tend to be difficult to use intuitively. Some of the existing financial investment software tools and products do not even allow the user to create a customer-specific system or indicators that are tailored to the user's specific needs. Further, thus far none of the existing financial investment software tools and products allows the user to define or formulate a strategy for investment, by directly interacting with financial charts, or automatically generates a user-defined strategy.

There are currently blogging systems which allow financial publishers to publish their research results and/or suggestions to their subscribers. However, thus far there has not been a system that allows a publisher to manage the subscription while publishing research results easily at the same time.

### SUMMARY

An objective of the present disclosure is to provide a method and apparatus to allow a user to do the following: (1) easily create and evaluate investment strategies for investment in the real financial market; (2) evaluate and provide improvement strategies based on past investment practices; (3) research and develop strategies based on the combination of market information, various traditional technical analysis, social media analysis and customized data mining results; (4) provide real-time analysis of social media trends and feedback loop with improvement on existing strategies; (5) publish and share individual systems/strategies and research results; and (6) subscribe to various investment strategies and publishers in a single forum.

In one aspect, a method of formulating and evaluating financial investment strategies is provided. The method may comprise: receiving, on an input device, a first user input from a user; receiving financial data from a data collecting service and a data mining service; storing the received data; computing to provide a user-specific investment strategy based at least on the first user input, a user profile of the user, a trading style of the user, and the received data; and displaying to the user, on an output device, the user-specific investment strategy.

In one embodiment, receiving the first user input from the user may comprise detecting one or more indications provided by the user relating to one or more regions of a graphical representation of an existing investment strategy, the user-specific investment strategy, or a chart of historical stock market data.

In one embodiment, the method may further comprise: receiving a second user input from the user indicative of one or more adjustments to the user-specific investment strategy; adjusting the user-specific investment strategy based on the second user input to provide an adjusted investment strategy; and displaying to the user a graphical representation of the adjusted investment strategy.

In one embodiment, the method may further comprise: computing a respective performance score for each of a plurality of existing investment strategies; ranking the existing investment strategies based on the respective performance scores of the existing investment strategies to provide a first ranking result; computing a respective performance score for each of a plurality of authors of financial news letters; ranking the authors of financial news letters based on the respective performance scores of the authors of financial news letters to provide a second ranking result; and displaying at least one of the first ranking result and the second ranking result to the user.

In one embodiment, the method may further comprise: receiving financial news letters from a plurality of authors of the financial news letters; and correlating the received financial news letters and the authors. The data received from the data collecting service may comprise at least the financial news letters, feeds from social networking websites, posts on social networking websites, or any combination thereof.

In one embodiment, the method may further comprise: monitoring financial market activities; computing market data based on the financial market activities to update financial market indicator values; determining whether or not at least one of the user-specific investment strategy and any of one or more existing investment strategies is triggered based on the financial market indicator values; and when at least one of the user-specific investment strategy or any of one or more existing investment strategies is triggered, notifying the user via electronic mail, text messaging, social networking information delivery means, or any combination thereof.

In one embodiment, the method may further comprise: receiving an indication from the user of a user-selected group of a plurality of stocks or a plurality of stock letter authors; and displaying to the user information related to the user-selected group of stocks or stock letter authors.

In another aspect, one or more computer-readable media storing computer-executable instructions that, when executed, may perform acts comprising: receiving user input from a user; storing data from one or more databases or data sources and financial market-related information from a data mining service; computing to provide a user-specific investment strategy based at least on the user input, a user profile of the user, a trading style of the user, and the financial market-related information; and displaying to the user the user-specific investment strategy.

In one embodiment, receiving user input from the user may comprise detecting one or more indications provided by the user relating to one or more regions of a graphical representation of an existing investment strategy, the user-specific investment strategy, or a chart of historical stock market data. The one or more indications provided by the user may indicate one or more conditions under which the user intends to buy or sell one or more stocks.

In one embodiment, the acts may further comprise: computing a respective performance score for each of a plurality of existing investment strategies; ranking the existing investment strategies based on the respective performance scores of the existing investment strategies to provide a first ranking result; computing a respective performance score for each of a plurality of authors of financial news letters; ranking the authors of financial news letters based on the respective performance scores of the authors of financial news letters to provide a second ranking result; and displaying at least one of the first ranking result and the second ranking result to the user.

In one embodiment, the acts may further comprise: receiving financial news letters from a plurality of authors of the financial news letters; and correlating the received financial news letters and the authors. The data from the one or more databases or data sources may comprise at least the financial news letters, feeds from social networking websites, posts on social networking websites, or any combination thereof.

In one embodiment, the acts may further comprise: monitoring financial market activities; computing market data based on the financial market activities to update financial market indicator values; determining whether or not at least one of the user-specific investment strategy and any of one or more existing investment strategies is triggered based on the financial market indicator values; and notifying the user when at least one of the user-specific investment strategy or any of one or more existing investment strategies is triggered. Notifying the user may comprise notifying the user via electronic mail, text messaging, social networking information delivery means, or any combination thereof.

In yet another aspect, an apparatus may comprise a data storage unit and a computation unit coupled to the data storage unit. The data storage unit may store user input from a user, data from one or more databases or data sources, financial market-related information from a data mining service, and a user-specific investment strategy that is computed based at least on the user input, a user profile of the user, a trading style of the user, and the financial market-related information. The computation unit may be configured to: cause the user-specific investment strategy or financial market data to be displayed; receive further user input from the user indicative of one or more adjustments to the user-specific investment strategy; and cause a graphical representation of the further user input to be displayed.

In one embodiment, the apparatus may further comprise a financial subscription unit that manages subscription to one or more financial news letters and stock letters, and correlates the one or more financial news letters and stock letters with one or more authors.

In one embodiment, the apparatus may further comprise a ranking and statistics unit that computes a respective performance score for each of the authors and ranks the authors according to the respective performance scores.

In one embodiment, the apparatus may further comprise a strategy formulation unit that generates one or more investment strategies based at least on the user input, the user profile of the user, the trading style of the user, the data from one or more databases or data sources, and the financial market-related information.

These and other objectives of the present disclosure will be appreciated by those of ordinary skill in the art after reading the following detailed description of the preferred embodiments that are illustrated in the various figures and drawings.

### BRIEF DESCRIPTION OF THE DRAWINGS

FIG. 1 is a block diagram of a system in accordance with an embodiment of the present disclosure.

FIG. 2 is a block diagram of general strategy formulation data flow in accordance with an embodiment of the present disclosure.

FIG. 3 is a block diagram of search data flow in accordance with an embodiment of the present disclosure.

FIG. 4 is a block diagram of notification data flow in accordance with an embodiment of the present disclosure.

FIG. 5 is a sample chart of historical stock market data presented to a user on an interactive user interface for the user to enter user input for strategy formulation in accordance with an embodiment of the present disclosure.

FIG. 6 is a sample trading data view presented to a user on an interactive user interface in accordance with an embodiment of the present disclosure.

FIG. 7 is a sample chart presented to a user on an interactive user interface for the user to enter user input for strategy formulation in accordance with an embodiment of the present disclosure.

FIG. 8 is a sample chart of technical indicators presented to a user on an interactive user interface for the user to adjust the technical indicators in accordance with an embodiment of the present disclosure.

FIG. 9 is a sample table of a group of user-selected stocks presented to a user on an interactive user interface in accordance with an embodiment of the present disclosure.

FIG. 10 is a flowchart of a process in accordance with an embodiment of the present disclosure.

FIG. 11 is a flowchart of a process in accordance with another embodiment of the present disclosure.

FIG. 12 is a functional block diagram of an apparatus in accordance with an embodiment of the present disclosure.

FIG. 13 is a block diagram of a computing device in accordance with an embodiment of the present disclosure.

### DETAILED DESCRIPTION OF PREFERRED EMBODIMENTS

### Overview

The aforementioned problems associated with existing financial investment software tools and products are addressed by the system, method and apparatus described herewith. The disclosed system, method and apparatus of formulating and evaluating investment strategies allow an amateur or semi-professional user of the system, apparatus or method to track and test the user's investment strategies without requiring the user to have knowledge or prior experience in programming. The disclosed technique provides an intuitive approach for the user by allowing the user to directly work on the graphical user interface, such as a chart, table or graph presented on a display device for example, by directly drawing on the presented chart, table or graph and marking one or more interested regions on the chart or graph to indicate the user's intended actions. Information available on the Internet and status information from social media portals are integrated into the charting in real time and presented to the user seamlessly. Accordingly, it is easy for an user to user the system without any prior knowledge to decide the strategy for investment.

Additionally, the disclosed system can serve as a centralized management system for financial letter publishing and subscription. Users of the disclosed system can upload their own data or records to be indexed and analyzed. The system can create specific indicators based on the user-uploaded indicators. Based on social media and past data analysis, the system can provide appropriate guidance on the chances that the market might be developing in a given coming period of time or timeframe.

### Example System

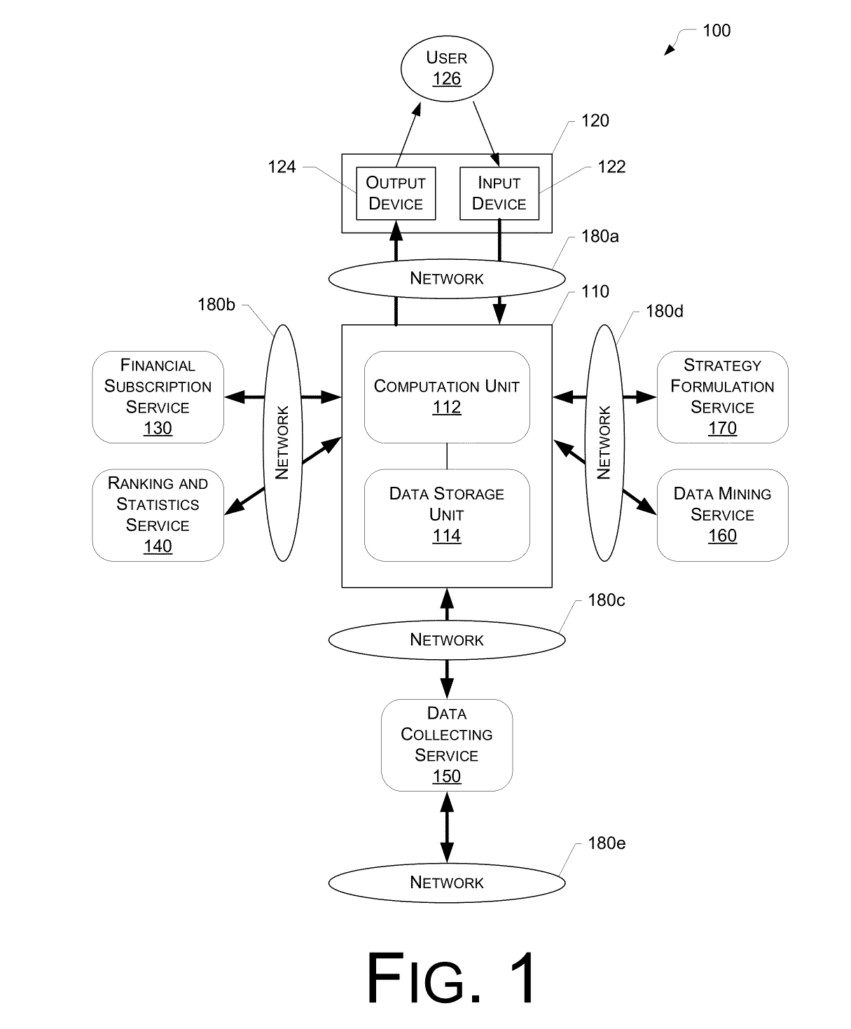

FIG. 1 illustrates a block diagram of a system 100 in accordance with an embodiment of the present disclosure. The system 100 comprises at least a server 110 and a client device 120 that are communicatively coupled to one another. In one embodiment, the server 110 and the client device 120 may be physically separate such that they are communicatively coupled over a network 180a. For example, the server 110 may be a server located in a first location while the client device 120 may be located in a second location remote from the first location. The network 180a may be, for example, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN) or the Internet. Although FIG. 1 shows the server 110 and the client device 120 communicate through the network 180a, in other embodiments the server 110 and the client device 120 communicate directly with one another and not through a network. In one embodiment, the server 110 and the client device 120 may be located in a physical proximity and communicatively coupled tougher via physical cables, wirings, wireless means, or a combination thereof. For example, the server 110 and the client device 120 may be directly coupled via an Ethernet cable. In another embodiment, at least a portion of the communication path between the server 110 and the client device 120 may be in accordance with one or more wireless standards such as, for example, IEEE 802.11 standards, WiFi, Bluetooth, infrared, WiMax, Long Term Evolution (LTE) and/or future versions and/or derivatives thereof.

The server 110 comprises at least a computation unit 112 and a data storage unit 114. The computation unit 112 may be a processor or a central processing unit of the server 110 that carries out instructions stored in the data storage unit 114. The data storage unit 114 may be, for example, volatile memory such as random access memory (RAM), non-volatile memory such as read-only memory (ROM), electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computation unit 112.

The client device 120 comprises an input device 122 and an output device 124. The input device 122 allows a user 126 to enter user input to be delivered to the server 110. The output device 124 displays or presents data received from the server 110 to the user 126. The data received from the server 110 and presented to the user 126 may be textual, numerical, graphical, or a combination thereof, and may include information in audio and/or video format. The client device 120 may be a computing device such as, for example, a portable electronic device, a smart phone, a notebook computer, a tablet computer, a personal digital assistant, a personal computer, a workstation computer, etc. The input device 122 and the output device 124 may be physically embodied in one device such as, for example, a table computer having a touch-sensing display panel. Although FIG. 1 shows the input device 122 and the output device 124 to be parts of the client device 120, in some embodiments the input device 122 and the output device 124 may be physically separate. For example, the input device 122 may be a keyboard, a computer mouse, an optical sensor or the like while the output device 124 may be a monitor, a flat panel display, and so on.

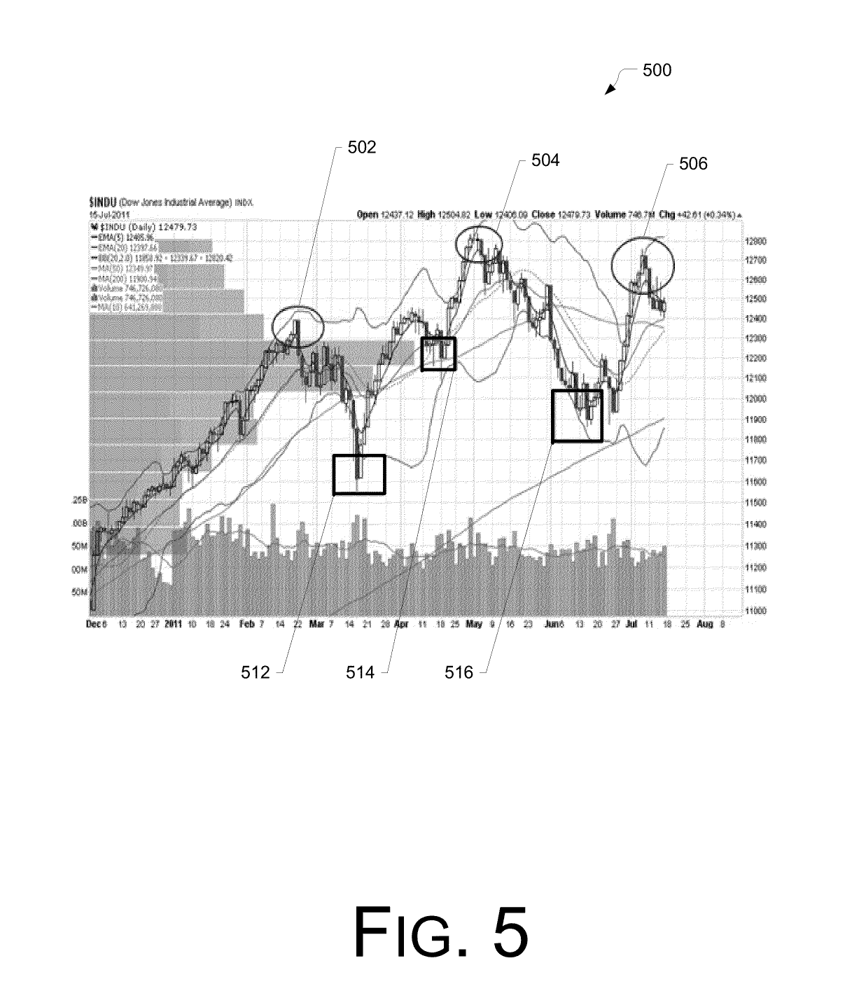

The client device 120, or more specifically the output device 124, can display a browser or an application that is executed to present data, such as financial information, to the user 126. The output device 124 provides major functionalities for the user 126 to log in and operate on the presented charts, tables and/or graphs via the input device 122. Data or information displayed on the output device 124 for presentation to the user 126 may include textual, numerical, graphical information, or any combination thereof, and may additionally or alternatively include audio and/or video data. Referring to FIG. 5, which illustrates a sample chart 500 of historical stock market data presented to the user 126 on the output device 124. As shown in FIG. 5, the user 126 can mark, via the input device 122, the peaks of the stock curve in circles to indicate his intention to sell the stocks in his stock portfolio during those periods of time. The user 126 can also mark, via the input device 122, the troughs of the stock curve in rectangles to indicate his intention to buy stocks during those periods of time.

In some embodiments, the system 100 may additionally comprise a financial subscription service 130 communicatively coupled to the server 110. In one embodiment, the financial subscription service 130 is communicatively coupled to the server 110 via a network such as network 180b. The financial subscription service 130 manages the subscription of stock letters and/or financial news letters for the user 126, and correlates the subscribed stock letters/financial news letters and the authors of those subscribed stock letters/financial news letters.

In some embodiments, the system 100 may additionally comprise a ranking and statistics service 140 communicatively coupled to the serve 110. In one embodiment, the ranking and statistics server 140 is communicatively coupled to the server 110 via a network such as the network 180b. The ranking and statistics server 140 computes a respective performance score for each of one or more investment strategies. Additionally or alternatively, the ranking and statistics server 140 computes a respective performance score for each of the authors of the subscribed stock letters and/or financial news letters.

Although the financial subscription service 130 and the ranking and statistics service 140 are shown as two separate modules in FIG. 1, in some embodiments they may be separate services provided by separate entities or performed on separate computing devices. In other embodiments they may be two separate functions provided by the same entity or performed on the same computing device. In still other embodiments, the functionalities of the financial subscription service 130 and the ranking and statistics service 140 may be performed by the computation unit 112 of the server 110.

The network 180b may or may not be the same network as the network 180a. The network 180b may be, for example, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN) or the Internet. Although FIG. 1 shows the server 110 communicates with the financial subscription service 130 and the ranking and statistics service 140 through the network 180b, in other embodiments the server 110 and either or both of the financial subscription service 130 and the ranking and statistics service 140 communicate directly and not through a network.

In some embodiments, the system 100 may additionally comprise a data collecting service 150 communicatively coupled to the serve 110. In one embodiment, the data collecting service 150 is communicatively coupled to the server 110 via a network such as the network 180c. The data collecting service 150 collects various data from a plurality of databases and/or data storages on the web and from users of the system 100. The collected data may include, for example, stock market information, financial investment information, financial news letters, feeds from social networking websites, posts on social networking websites, or any combination thereof. The feeds from social networking websites may include, for example, feeds from the social networking website provided by Twitter of San Francisco, Calif. or Facebook of Cambridge, Mass. The posts on social networking websites may include, for example, posts on Google+ provided by Google Inc. of Mountain View, Calif.

The network 180c may or may not be the same network as the network 180a or network 180b. The network 180c may be, for example, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN) or the Internet. Although FIG. 1 shows the server 110 communicates with the data collecting service 150 through the network 180c, in other embodiments the server 110 and the data collecting service 150 communicate directly with one another and not through a network.

In some embodiments, the system 100 may additionally comprise a data mining service 160 communicatively coupled to the serve 110. In one embodiment, the data mining service 160 is communicatively coupled to the server 110 via a network such as the network 180d. The data mining service 160 conducts data mining, to recognize new patterns not previously-known in the collected data sets, and machine learning based on the data collected by the data collecting service 150.

In some embodiments, the system 100 may further comprise a strategy formulation service 170 communicatively coupled to the server 110. In one embodiment, the strategy formulation service 170 is communicatively coupled to the service 110 via a network such as the network 180d. The strategy formulation service 170 computes and provides user-specific strategies based on the user profile of the user 126, trading style of the user 126 and the results from the data mining service 160.

The network 180d may or may not be the same network as the network 180a, network 180b or network 180c. The network 180d may be, for example, a local area network (LAN), a wireless LAN (WLAN), a metropolitan area network (MAN), a wireless MAN (WMAN), a wide area network (WAN), a wireless WAN (WWAN), a personal area network (PAN), a wireless PAN (WPAN) or the Internet. Although FIG. 1 shows the server 110 communicates with the data mining service 160 and the strategy formulation service 170 through the network 180c, in other embodiments the server 110 communicates with either or both of the data mining service 160 and the strategy formulation service 170 directly and not through a network.

Although the data mining service 150, the data mining service 160 and the strategy formulation service 170 are shown as separate modules in FIG. 1, in some embodiments they may be separate services provided by separate entities or performed on separate computing devices. In other embodiments they may be separate functions provided by the same entity or performed on the same computing device. In still other embodiments, the functionalities of the data mining service 150, the data mining service 160 and the strategy formulation service 170 may be performed by the computation unit 112 of the server 110.

The server 110 stores the data and information received from the user 126, the financial subscription service 130, the ranking and statistics service 140, the data collecting service 150, the data mining service 160 and the strategy formulation service 170 in the data storage unit 114. The computation unit 112 performs computational tasks based at least on the data stored in the data storage unit 114 as well as data and information received in real time from the aforementioned components of the system 110.

Benefits offered by the system 100 may include the following: (1) a user is able to submit his past investment record for review, analysis and suggestion on improvements pursuant to the user's style; (2) the user is able to create investment strategies by indicating interested regions directly on a chart, table or graph presented on the output device 124 (e.g., a display panel with touch-sensing capability); (3) the system 100 associates data with the latest social media analysis, such as twitter trending data, from various sources and presents the result to the user in real time; (4) usage of the system 100 is intuitive and simple, and no prior programming knowledge is required for an average user; (5) the system 100 can be on 24 hours a day and seven days a week, and does not require maintenance from the user's perspective; (6) the system 100 integrates in real time any relevant information including posts, feeds and trend data from social networking websites; (7) it is easy for a user to publish and share one or more investment strategies of the user with other users; (8) the system 100 utilizes collective intelligence from other investors; and (9) the system 100 can provide probability-based guidance on future development.

It shall be appreciated by those of ordinary skill in the art that system 100 of FIG. 1 represents a general concept of the various embodiments of the present disclosure. Various modifications to system 100 may be made and still be within the scope of the present disclosure. For example, there may be additional components or fewer components in a similar system than those illustrated in FIG. 1. Moreover, although the various components of the system 100 are shown in FIG. 1 as discrete and separate from one another, in some embodiments some of them may be embodied in the same software module or hardware device while the remaining components may be embodied in different software modules or hardware devices, and in other embodiments all of them may be embodied in the same software module or hardware device.

### Example Data Flows

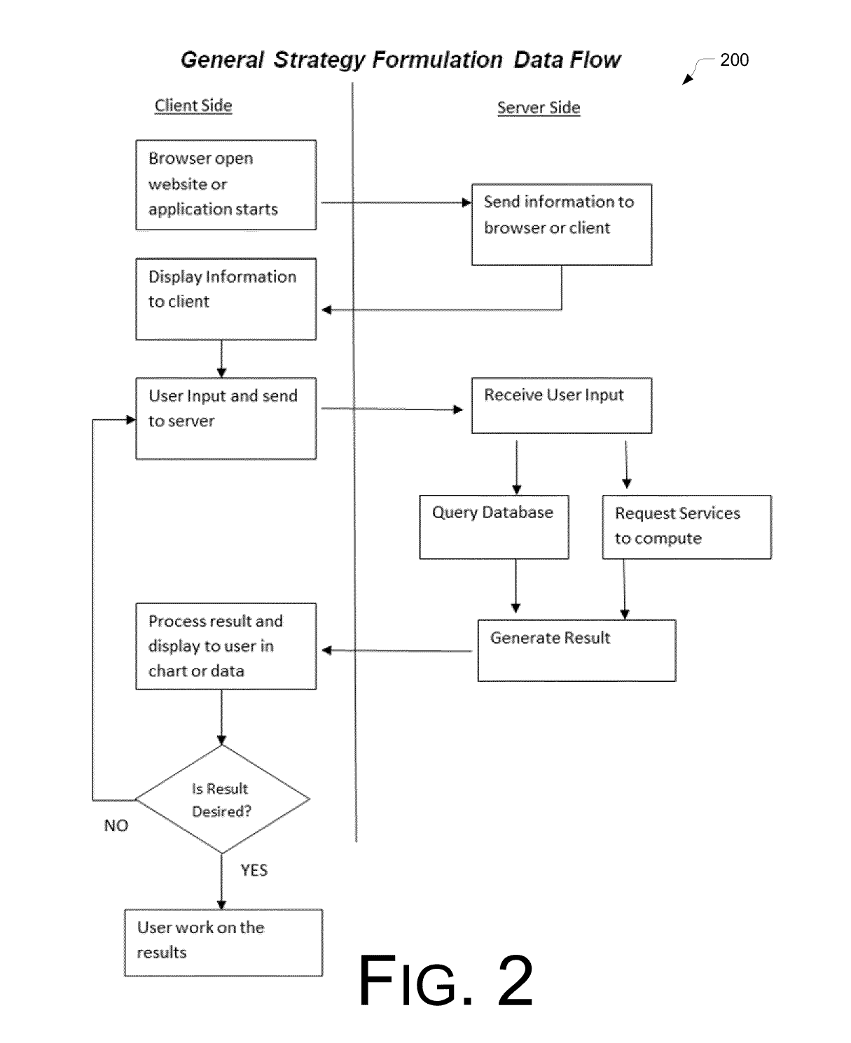

FIG. 2 illustrates a block diagram of general strategy formulation data flow 200 in accordance with an embodiment of the present disclosure. With reference to FIG. 1, the client side as shown in FIG. 2 represents actions occurring with respect to the user 126, while the server side as shown in FIG. 2 represents actions occurring with respect to the server 110. As shown in FIG. 2, a browser opens a website or an application is started, and such action is displayed to the user 126 on the output device 124. The server 110 sends information to the browser to be presented to the user 126, and such information is displayed to the user 126 on the output device 124. The user 126 makes user input via the input device 122 to be sent to the server 110. Upon receiving the user input, the server 110 queries a database, such as a database stored in the data storage unit 114, and the server 110 also requests results from the various services, such as the financial subscription service 130, the ranking and statistics service 140, the data collecting service 150, the data mining service 160, and the strategy formulation service 170. The server 110, or more specifically the computation unit 112, carries out computation based on the received data to generate one or more results such as, for example, a user-specific investment strategy. The one or more results are processed and displayed to the user 126 in the form of charts, tables and/or graphs and may include textual, alphanumerical information, audio data and/or video data. Upon viewing the displayed data on the output device 124, the user 126 determines whether or not the displayed result, e.g., a new user-specific investment strategy, is desired. If not, the user 126 can make further user inputs to obtain new or modified results.

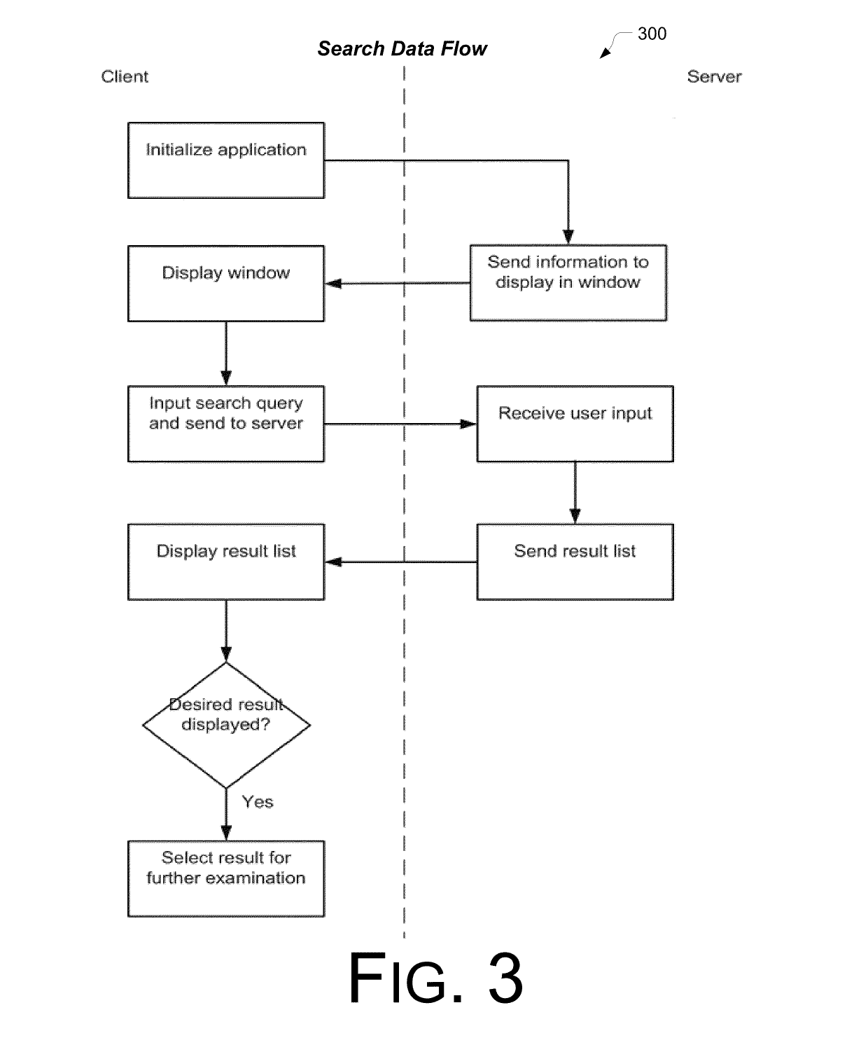

FIG. 3 illustrates a block diagram of search data flow 300 in accordance with an embodiment of the present disclosure. With reference to FIG. 1, the client side as shown in FIG. 3 represents actions occurring with respect to the user 126, while the server side as shown in FIG. 3 represents actions occurring with respect to the server 110. As shown in FIG. 3, the user 126 initializes an application residing on the server 110 by making a user input via the input device 122. In response, the server 110 sends information to be displayed to the user 126 on the output device 124, for example, via a window or browser displayed on the output device 124. The user 126 inputs a search query via the input device 122 to be sent to the server 110. Upon receiving the search query from the user 126 via the input device 122, the server 110 conducts a search and sends a results list to the output device 124 which displays the result list to the user 126. The user 126 may then selects a result from the result list for further examination.

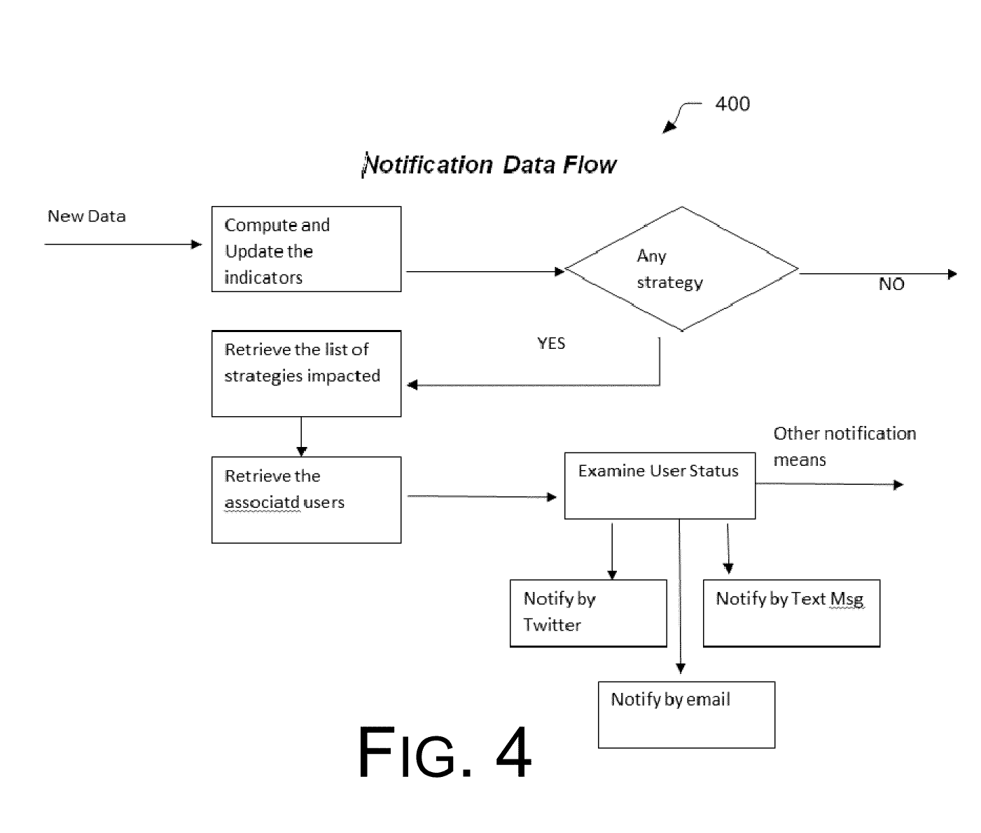

FIG. 4 illustrates a block diagram of notification data flow 400 in accordance with an embodiment of the present disclosure. With reference to FIG. 1, upon receiving new data (e.g., from the financial subscription service 130, the ranking and statistics service 140, the data collecting service 150, the data mining service 160 and/or the strategy formulation service 170), the computation unit 112 of the server 110 computes and updates financial indicators, and determines whether or not there is any of the existing investment strategies may be impacted. If so, the computation unit 112 retrieves the list of investment strategies that are impacted in view of the newly received data. The computation unit 112 then retrieves a list of users who are associated with the impacted investment strategies, and examines the user status of these users. If a user on the list of users who are associated with the impacted investment strategies is still an active user, the system 100 notifies such user by any means available and acceptable to the user such as, for example, via feeds or posts on one or more social networking media, electronic mail, text messaging, phone call or any other suitable means of communication.

### Example Displays of Sample Data

FIG. 5 illustrates a sample chart 500 of historical stock market data presented to a user on an interactive user interface for the user to enter user input for strategy formulation in accordance with an embodiment of the present disclosure. With reference to FIG. 1, FIG. 5 illustrates a sample chart 500 of historical stock market data presented to the user 126 on the output device 124. As shown in FIG. 5, the user 126 can mark, via the input device 122, the peaks of the stock curve in circles, such as circles 502, 504 and 506, to indicate his intention to sell the stocks in his stock portfolio during those periods of time. The user 126 can also mark, via the input device 122, the troughs of the stock curve in rectangles, such as rectangles 512, 514 and 516, to indicate his intention to buy stocks during those periods of time.

The user 126 can indicate the actions, such as buy and sell, on the historical data chart 500. With such user input, the system 100 can automatically generate a best investment strategy by analyzing the data stored in the data storage unit 114 and various data input to suggest an adjusted investment strategy to the user 126. The user 126 can then tune the given strategy based on the suggestion. The user interface allows the user 126 to directly mark any interested region, such as the peaks and/or troughs of the chart 500, for example.

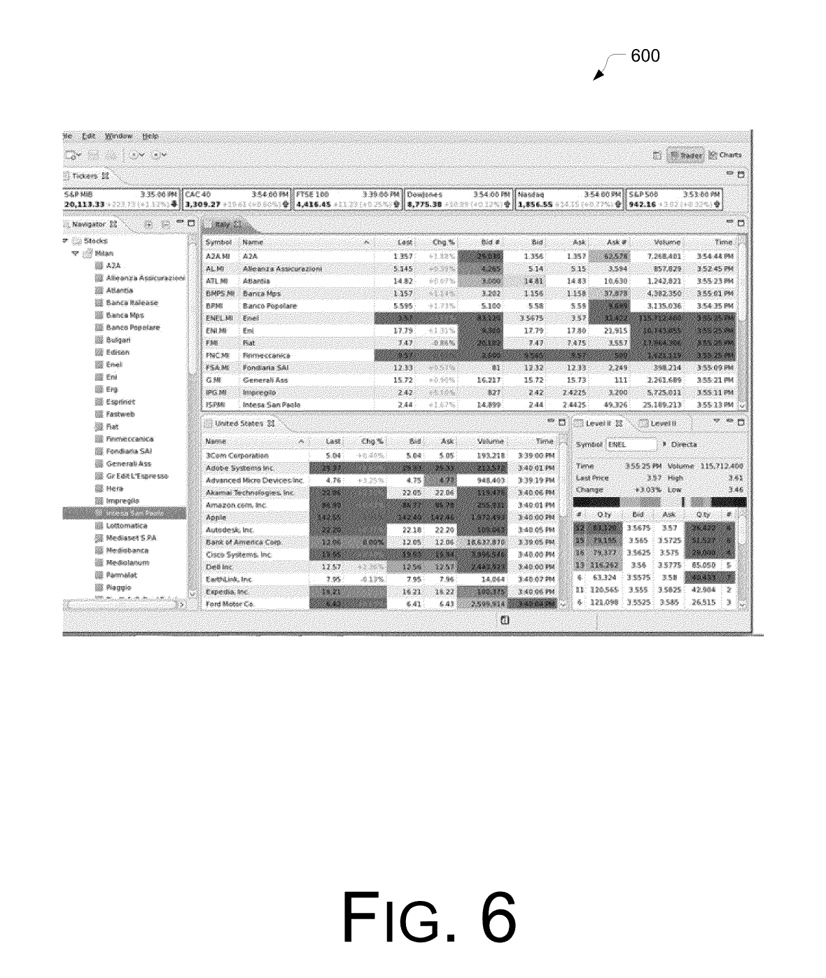

FIG. 6 illustrates a sample trading data view 600 presented to a user on an interactive user interface in accordance with an embodiment of the present disclosure.

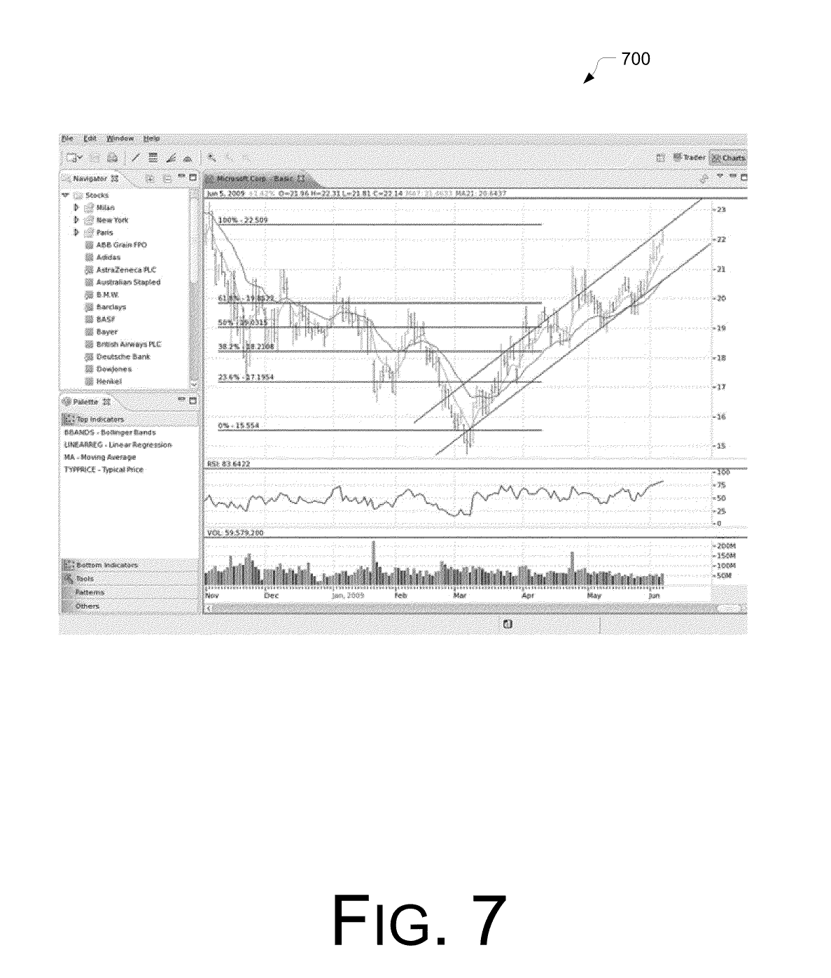

FIG. 7 illustrates a sample chart 700 presented to a user on an interactive user interface for the user to enter user input for strategy formulation in accordance with an embodiment of the present disclosure.

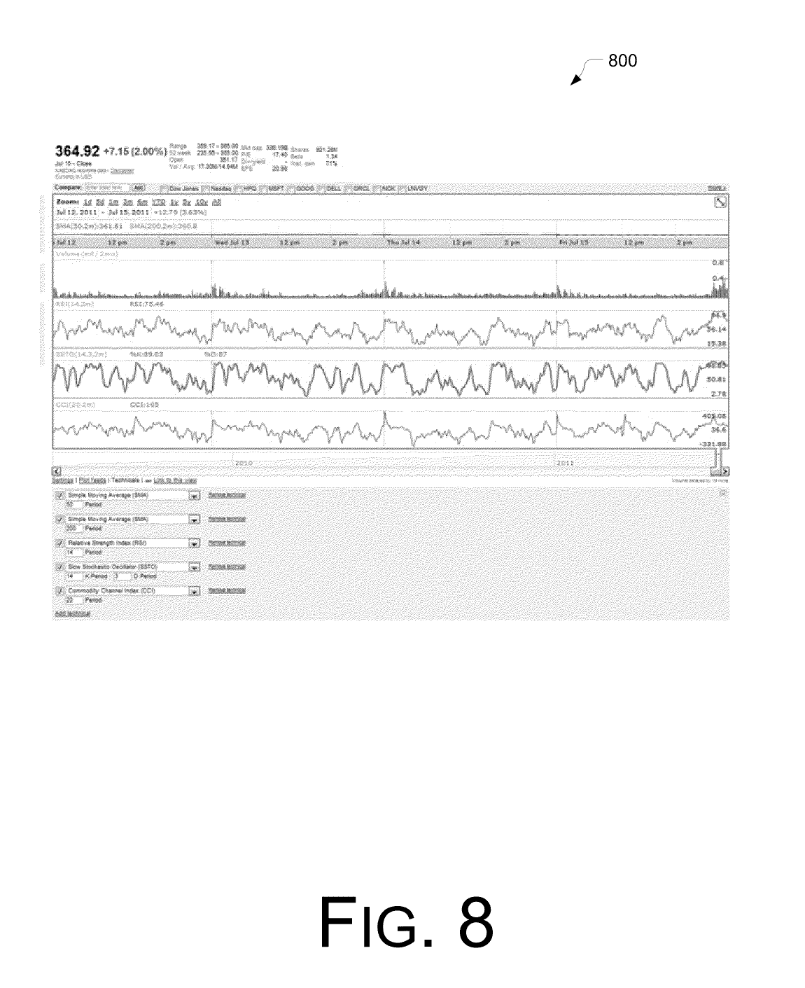

FIG. 8 illustrates a sample chart 800 of technical indicators presented to a user on an interactive user interface for the user to adjust the technical indicators in accordance with an embodiment of the present disclosure. The upper portion of the chart 800 includes technical indicators charts. The bottom portion of the chart 800 provides the options for a user to adjust the technical indicators.

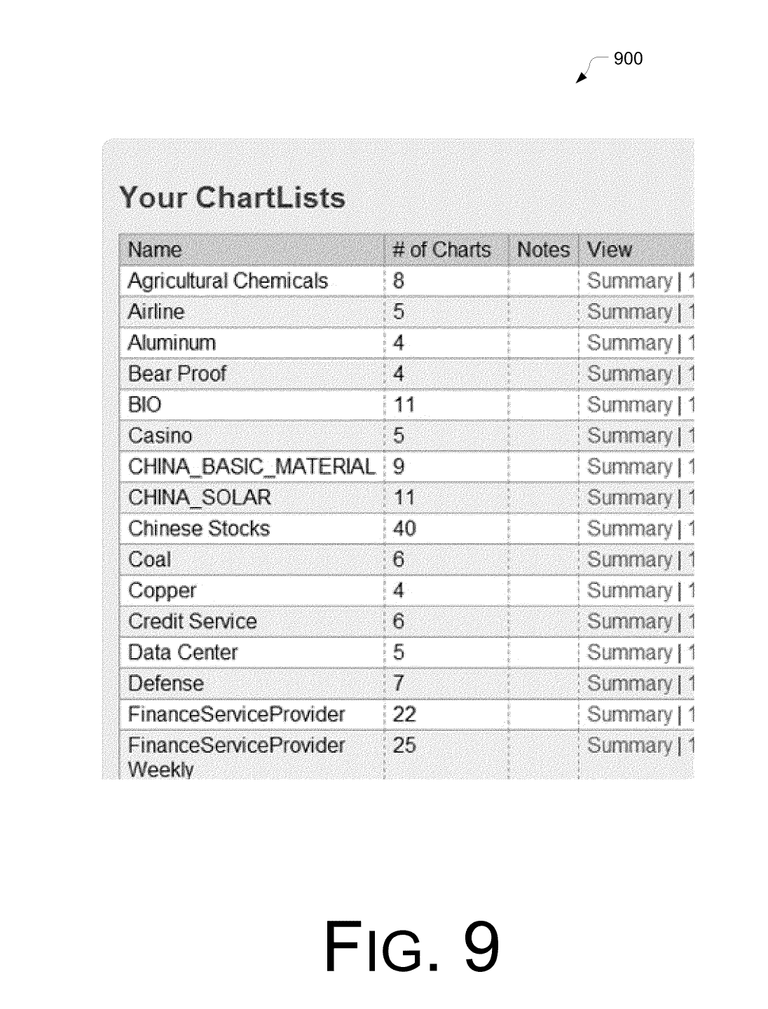

FIG. 9 illustrates a sample table 900 of a group of user-selected stocks presented to a user on an interactive user interface in accordance with an embodiment of the present disclosure. The user is allowed to group a plurality of stocks and/or authors of stock letters/financial news letters into lists. Then, a list of user-selected group of stocks, such as that shown in FIG. 9, or a list of user-selected group of authors can be presented to the user.

### Example Processes

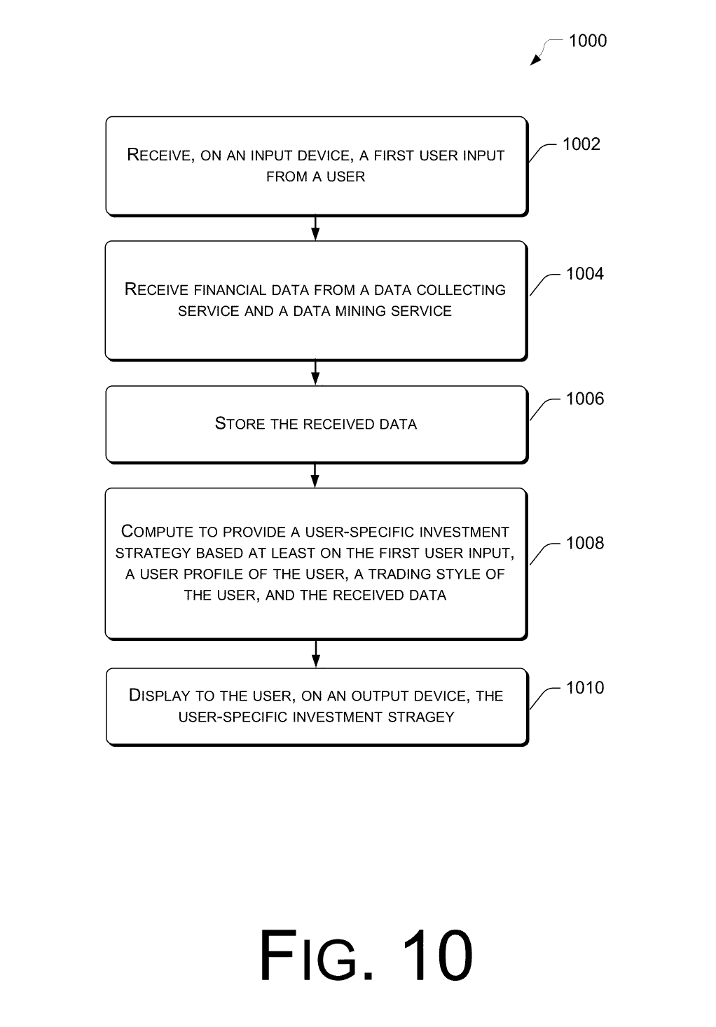

FIG. 10 illustrates a flowchart of a process 1000 in accordance with an embodiment of the present disclosure. In one or more embodiments, one or more of the operations of the process 1000 may be omitted, repeated, and/or performed in a different order. Accordingly, the specific arrangement of operations shown in FIG. 10 should not be construed as limiting the scope of the technique.

The process 1000 may be a method of formulating and evaluating financial investment strategies. At 1002, the process receives, on an input device, a first user input from a user. At 1004, the process 1000 receives financial data from a data collecting service and a data mining service. At 1006, the process 1000 stores the received data. At 1008, the process 1000 computes to provide a user-specific investment strategy based at least on the first user input, a user profile of the user, a trading style of the user, and the received data. At 1010, the process 1000 displays to the user, on an output device, the user-specific investment strategy.

In one embodiment, receiving the first user input from the user may comprise detecting one or more indications provided by the user relating to one or more regions of a graphical representation of an existing investment strategy, the user-specific investment strategy, or a chart of historical stock market data. For example, as shown in FIG. 5, the user 126 can mark, via the input device 122, the peaks of the stock curve in circles to indicate his intention to sell the stocks in his stock portfolio during those periods of time. The user 126 can also mark, via the input device 122, the troughs of the stock curve in rectangles to indicate his intention to buy stocks during those periods of time.

In one embodiment, the process 1000 may further comprise: receiving a second user input from the user indicative of one or more adjustments to the user-specific investment strategy; adjusting the user-specific investment strategy based on the second user input to provide an adjusted investment strategy; and displaying to the user a graphical representation of the adjusted investment strategy.

In one embodiment, the process 1000 may further comprise: computing a respective performance score for each of a plurality of existing investment strategies; ranking the existing investment strategies based on the respective performance scores of the existing investment strategies to provide a first ranking result; computing a respective performance score for each of a plurality of authors of financial news letters; ranking the authors of financial news letters based on the respective performance scores of the authors of financial news letters to provide a second ranking result; and displaying at least one of the first ranking result and the second ranking result to the user.

In one embodiment, the process 1000 may further comprise: receiving financial news letters from a plurality of authors of the financial news letters; and correlating the received financial news letters and the authors. The data received from the data collecting service may comprise at least the financial news letters, feeds from social networking websites, posts on social networking websites, or any combination thereof.

In one embodiment, the process 1000 may further comprise: monitoring financial market activities; computing market data based on the financial market activities to update financial market indicator values; determining whether or not at least one of the user-specific investment strategy and any of one or more existing investment strategies is triggered based on the financial market indicator values; and when at least one of the user-specific investment strategy or any of one or more existing investment strategies is triggered, notifying the user via electronic mail, text messaging, social networking information delivery means, or any combination thereof.

In one embodiment, the process 1000 may further comprise: receiving an indication from the user of a user-selected group of a plurality of stocks or a plurality of stock letter authors; and displaying to the user information related to the user-selected group of stocks or stock letter authors.

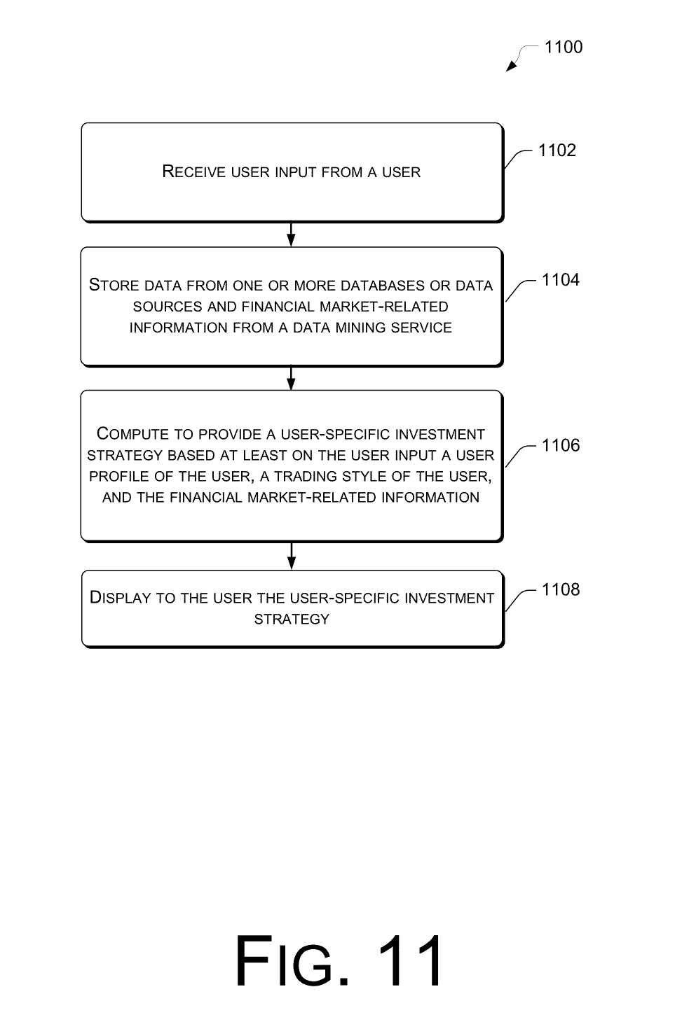

FIG. 11 illustrates a flowchart of a process 1100 in accordance with another embodiment of the present disclosure. In one or more embodiments, one or more of the operations of the process 1100 may be omitted, repeated, and/or performed in a different order. Accordingly, the specific arrangement of operations shown in FIG. 11 should not be construed as limiting the scope of the technique.

The process 1100 may be a method of formulating and evaluating financial investment strategies. At 1102, the process 1100 receives user input from a user. At 1104, the process 1100 stores data from one or more databases or data sources and financial market-related information from a data mining service. At 1106, the process 1100 computes to provide a user-specific investment strategy based at least on the user input, a user profile of the user, a trading style of the user, and the financial market-related information. At 1108, the process 1100 displays to the user the user-specific investment strategy.

In one embodiment, receiving user input from the user may comprise detecting one or more indications provided by the user relating to one or more regions of a graphical representation of an existing investment strategy, the user-specific investment strategy, or a chart of historical stock market data. The one or more indications provided by the user may indicate one or more conditions under which the user intends to buy or sell one or more stocks.

In one embodiment, the process 1100 may further comprise: computing a respective performance score for each of a plurality of existing investment strategies; ranking the existing investment strategies based on the respective performance scores of the existing investment strategies to provide a first ranking result; computing a respective performance score for each of a plurality of authors of financial news letters; ranking the authors of financial news letters based on the respective performance scores of the authors of financial news letters to provide a second ranking result; and displaying at least one of the first ranking result and the second ranking result to the user.

In one embodiment, the process 1100 may further comprise: receiving financial news letters from a plurality of authors of the financial news letters; and correlating the received financial news letters and the authors. The data from the one or more databases or data sources may comprise at least the financial news letters, feeds from social networking websites, posts on social networking websites, or any combination thereof.

In one embodiment, the process 1100 may further comprise: monitoring financial market activities; computing market data based on the financial market activities to update financial market indicator values; determining whether or not at least one of the user-specific investment strategy and any of one or more existing investment strategies is triggered based on the financial market indicator values; and notifying the user when at least one of the user-specific investment strategy or any of one or more existing investment strategies is triggered. Notifying the user may comprise notifying the user via electronic mail, text messaging, social networking information delivery means, or any combination thereof.

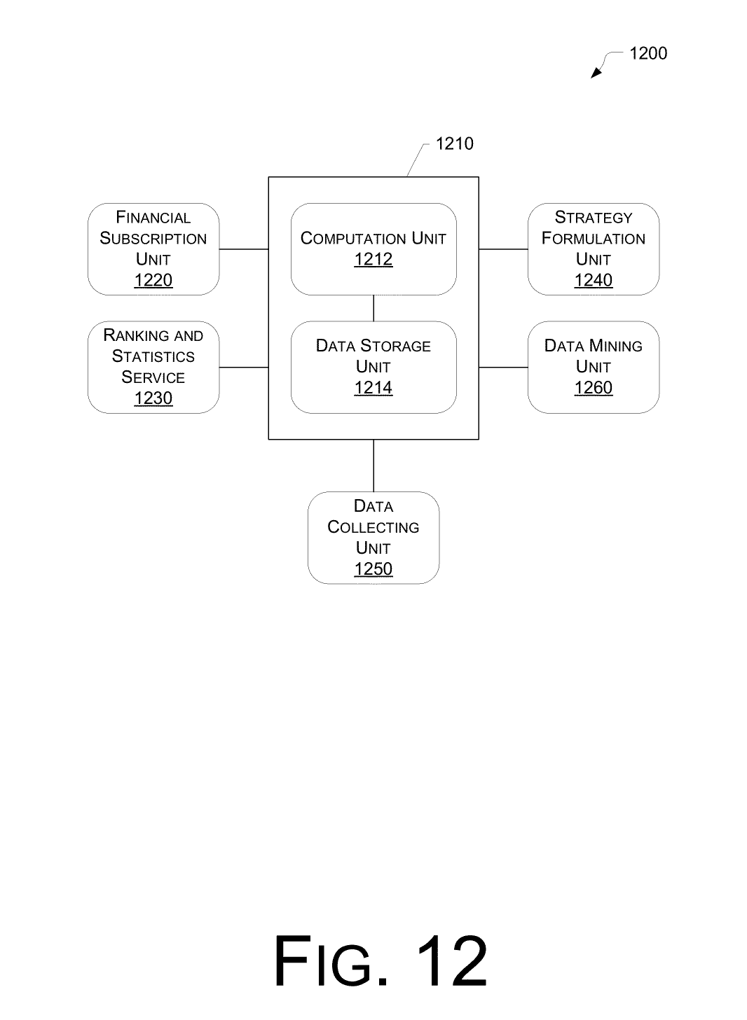

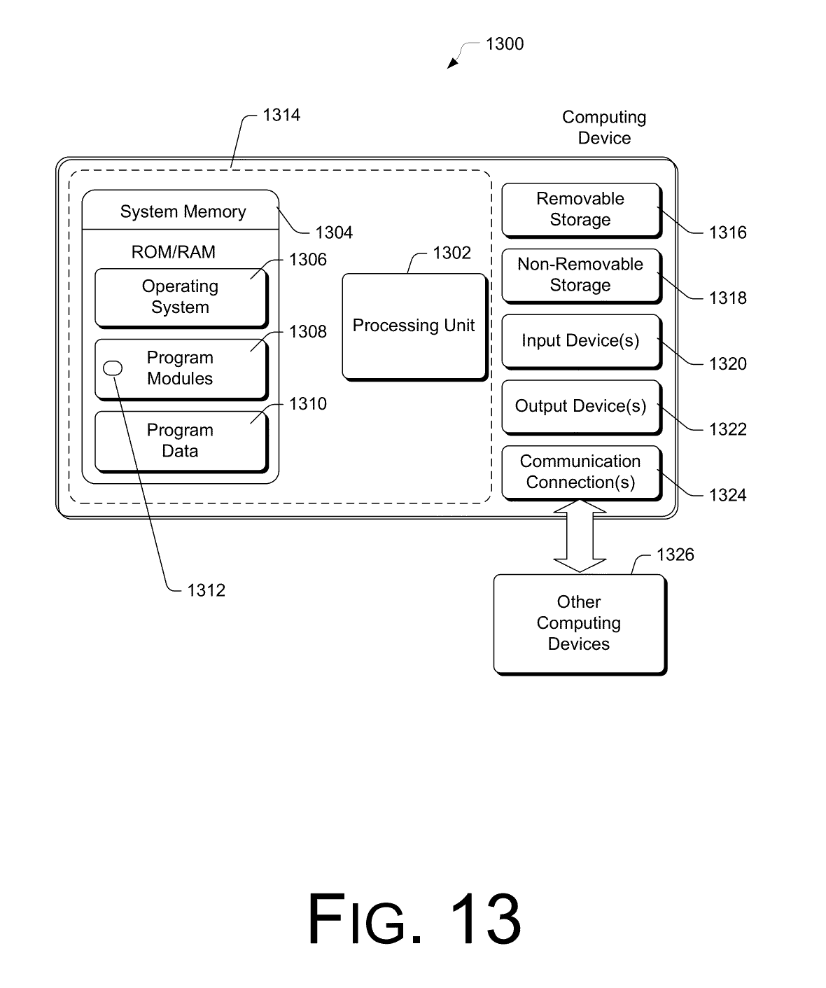

Process 1000 and process 1100, or any variations thereof, may be carried out as a result of executing instructions, e.g., computer programming codes, stored on one or more computer-readable storage medium by a processor, a central processing unit, a computing device such as, for example, the computation unit 112 of the server 110 of the system 100 of FIG. 1, the apparatus 1200 of FIG. 12, or the computing device 1300 of FIG. 13. Such one or more computer-readable storage medium may be one or more tangible storage device including, but not limited to, random access memory (RAM), read-only memory (ROM), electrically erasable programmable read-only memory (EEPROM), flash memory or other memory technology, compact disc read-only memory (CD-ROM), digital versatile disks (DVD), any optical storage, magnetic cassettes, magnetic tape, magnetic disk storage or other magnetic storage devices, or any other non-transitory medium which can be used to store the desired information now known or later developed and which can be accessed by a processor, a central processing unit, a computing device such as, for example, the computation unit 112 of the server 110 of the system 100 of FIG. 1, the apparatus 1200 of FIG. 12, or the computing device 1300 of FIG. 13. In the present disclosure, the term “one or more computer-readable storage medium” does not encompass any non-tangible or transitory propagating signal such as, for example, electromagnetic or acoustic signal or waveform and shall not be interpreted as such.

### Example Apparatus

FIG. 12 illustrates a functional block diagram of an apparatus 1200 in accordance with an embodiment of the present disclosure. The apparatus 1200 may comprise a data storage unit 1214 and a computation unit 1212 coupled to the data storage unit 1214. The data storage unit 1214 may store user input from a user, data from one or more databases or data sources, financial market-related information from a data mining service, and a user-specific investment strategy that is computed based at least on the user input, a user profile of the user, a trading style of the user, and the financial market-related information. The computation unit 1212 may be configured to: cause the user-specific investment strategy or financial market data to be displayed; receive further user input from the user indicative of one or more adjustments to the user-specific investment strategy; and cause a graphical representation of the further user input to be displayed. In some embodiments, the computation unit 1212 and the data storage unit 1214 may be embodied in the same software module or hardware device such as a server 1210 shown in FIG. 1200. In other embodiments, the computation unit 1212 and the data storage unit 1214 may be embodied in different software modules or hardware devices.

In some embodiments, the apparatus 1200 may further comprise a financial subscription unit 1220 that manages subscription to one or more financial news letters and stock letters, and correlates the one or more financial news letters and stock letters with one or more authors.

In some embodiments, the apparatus 1200 may further comprise a ranking and statistics unit 1230 that computes a respective performance score for each of the authors and ranks the authors according to the respective performance scores.

In some embodiments, the apparatus 1200 may further comprise a strategy formulation unit 1240 that generates one or more investment strategies based at least on the user input, the user profile of the user, the trading style of the user, the data from one or more databases or data sources, and the financial market-related information.

In some embodiments, the apparatus 1200 may further comprise a data collecting unit 1250 that acts as a data collecting service by providing the data collected from various databases and/or data sources to the data storage unit 1214. The collected data may include, for example, stock market information, financial investment information, financial news letters, feeds from social networking websites, posts on social networking websites, or any combination thereof.

In some embodiments, the apparatus 1200 may further comprise a data mining unit 1260 that acts as the data mining service and conducts data mining, to recognize new patterns not previously-known in the collected data sets, and machine learning based on the data collected by the data collecting unit 1250. The data mining unit 1260 provides financial market-related information, including any patterns recognized in the collected data, to the data storage unit 1214.

The apparatus 1200 is capable of carrying out the functionalities of the various components of the system 100 and executing the process 1000 and the process 1100. The various components of the apparatus 1200 may be embodied in one or more software modules, hardware devices, or any combination thereof.

### Example Computing Device

FIG. 1300 illustrates a representative computing device 1300 that may implement the techniques for formulation and evaluation of investment strategies. However, it will be readily appreciated that the techniques disclosed herein may be implemented in other computing devices, systems, and environments. The computing device 1300 shown in FIG. 13 is only one example of a computing device and is not intended to suggest any limitation as to the scope of use or functionality of the computer and network architectures.

In at least one configuration, computing device 1300 typically includes at least one processing unit 1302 and system memory 1304. Depending on the exact configuration and type of computing device, system memory 1304 may be volatile (such as RAM), non-volatile (such as ROM, flash memory, etc.) or some combination thereof. System memory 1304 may include an operating system 1306, one or more program modules 1308, and may include program data 1310. The computing device 1300 is of a very basic configuration demarcated by a dashed line 1314. Again, a terminal may have fewer components but may interact with a computing device that may have such a basic configuration.

In one embodiment, the program module 1308 includes an investment strategy formulation and evaluation module 1312. The investment strategy formulation and evaluation module 1312 can carry out one or more functionalities and processes as described above with reference to FIGS. 1-12. For example, when the investment strategy formulation and evaluation module 1312 is properly configured, the computing device 1300 can carry out the operations of process 1000 of FIG. 10 and variations thereof as well as process 1100 of FIG. 11 and variations thereof.

Computing device 1300 may have additional features or functionality. For example, computing device 1300 may also include additional data storage devices (removable and/or non-removable) such as, for example, magnetic disks, optical disks, or tape. Such additional storage is illustrated in FIG. 13 by removable storage 1316 and non-removable storage 1318. Computer storage media may include volatile and nonvolatile, removable and non-removable media implemented in any method or technology for storage of information, such as computer readable instructions, data structures, program modules, or other data. System memory 1304, removable storage 1316 and non-removable storage 1318 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1300. Any such computer storage media may be part of the computing device 1300. Computing device 1300 may also have input device(s) 1320 such as keyboard, mouse, pen, voice input device, touch input device, etc. Output device(s) 1322 such as a display, speakers, printer, etc. may also be included.

Computing device 1300 may also contain communication connections 1324 that allow the device to communicate with other computing devices 1326, such as over a network. These networks may include wired networks as well as wireless networks. Communication connections 1324 are some examples of communication media. Communication media may typically be embodied by computer readable instructions, data structures, program modules, etc.

It is appreciated that the illustrated computing device 1300 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-base systems, set top boxes, game consoles, programmable consumer electronics, network PCs, minicomputers, mainframe computers, distributed computing environments that include any of the above systems or devices, and/or the like.

### CONCLUSION

In summary, the present disclosure provides a system, method and apparatus to formulate and evaluate investment strategies. Benefits offered by the disclosed system, method and apparatus are numerous, including: (1) a user is able to submit his past investment record for review, analysis and suggestion on improvements pursuant to the user's style; (2) the user is able to create investment strategies by indicating interested regions directly on a chart, table or graph presented on a display device (e.g., a display panel with touch-sensing capability); (3) the system associates data with the latest social media analysis, such as twitter trending data, from various sources and presents the result to the user in real time; (4) usage of the system is intuitive and simple, and no prior programming knowledge is required for an average user; (5) the system can be on 24/7, and does not require maintenance from the user's perspective; (6) the system integrates in real time any relevant information including posts, feeds and trend data from social networking websites; (7) it is easy for a user to publish and share one or more investment strategies of the user with other users; (8) the system utilizes collective intelligence from other investors; and (9) the system can provide probability-based guidance on future development.

Those skilled in the art will readily observe that numerous modifications and alterations of the device and method may be made while retaining the teachings of the present disclosure.

What is claimed is:

1. A method of formulating and evaluating financial investment strategies, the method comprising:
receiving, on an input device, a first user input from a user;
receiving financial data from a data collecting service and a data mining service;
storing the received data;
computing to provide a user-specific investment strategy based at least on the first user input, a user profile of the user, a trading style of the user, and the received data; and
displaying to the user, on an output device, the user-specific investment strategy.

2. The method of claim 1, wherein receiving the first user input from the user comprises detecting one or more indications provided by the user relating to one or more regions of a graphical representation of an existing investment strategy, the user-specific investment strategy, or a chart of historical stock market data.

3. The method of claim 1, further comprising:
receiving a second user input from the user indicative of one or more adjustments to the user-specific investment strategy;
adjusting the user-specific investment strategy based on the second user input to provide an adjusted investment strategy; and
displaying to the user a graphical representation of the adjusted investment strategy.

4. The method of claim 1, further comprising:
computing a respective performance score for each of a plurality of existing investment strategies;
ranking the existing investment strategies based on the respective performance scores of the existing investment strategies to provide a first ranking result;
computing a respective performance score for each of a plurality of authors of financial news letters;
ranking the authors of financial news letters based on the respective performance scores of the authors of financial news letters to provide a second ranking result; and
displaying at least one of the first ranking result and the second ranking result to the user.

5. The method of claim 1, further comprising:
receiving financial news letters from a plurality of authors of the financial news letters; and
correlating the received financial news letters and the authors.

6. The method of claim 5, wherein the data received from the data collecting service comprises at least the financial news letters, feeds from social networking websites, posts on social networking websites, or any combination thereof.

7. The method of claim 1, further comprising:
monitoring financial market activities;
computing market data based on the financial market activities to update financial market indicator values;
determining whether or not at least one of the user-specific investment strategy and any of one or more existing investment strategies is triggered based on the financial market indicator values; and
when at least one of the user-specific investment strategy or any of one or more existing investment strategies is triggered, notifying the user via electronic mail, text messaging, social networking information delivery means, or any combination thereof.

8. The method of claim 1, further comprising:
receiving an indication from the user of a user-selected group of a plurality of stocks or a plurality of stock letter authors; and
displaying to the user information related to the user-selected group of stocks or stock letter authors.

9. A computer-readable storage medium storing computer-executable instructions that, when executed, perform acts comprising:
receiving user input from a user;
storing data from one or more databases or data sources and financial market-related information from a data mining service;
computing to provide a user-specific investment strategy based at least on the user input, a user profile of the user, a trading style of the user, and the financial market-related information; and
displaying to the user the user-specific investment strategy.

10. The computer-readable storage medium of claim 9, wherein receiving user input from the user comprises detecting one or more indications provided by the user relating to one or more regions of a graphical representation of an existing investment strategy, the user-specific investment strategy, or a chart of historical stock market data.

11. The computer-readable storage medium of claim 10, wherein the one or more indications provided by the user indicate one or more conditions under which the user intends to buy or sell one or more stocks.

12. The computer-readable storage medium of claim 9, wherein the acts further comprise:
computing a respective performance score for each of a plurality of existing investment strategies;
ranking the existing investment strategies based on the respective performance scores of the existing investment strategies to provide a first ranking result;
computing a respective performance score for each of a plurality of authors of financial news letters;
ranking the authors of financial news letters based on the respective performance scores of the authors of financial news letters to provide a second ranking result; and
displaying at least one of the first ranking result and the second ranking result to the user.

13. The computer-readable storage medium of claim 9, wherein the acts further comprise:
receiving financial news letters from a plurality of authors of the financial news letters; and
correlating the received financial news letters and the authors.

14. The computer-readable storage medium of claim 13, wherein the data from the one or more databases or data sources comprises at least the financial news letters, feeds from social networking websites, posts on social networking websites, or any combination thereof.

15. The computer-readable storage medium of claim 9, wherein the acts further comprise:
monitoring financial market activities;
computing market data based on the financial market activities to update financial market indicator values;
determining whether or not at least one of the user-specific investment strategy and any of one or more existing investment strategies is triggered based on the financial market indicator values; and
notifying the user when at least one of the user-specific investment strategy or any of one or more existing investment strategies is triggered.

16. The computer-readable storage medium of claim 15, wherein notifying the user comprises notifying the user via electronic mail, text messaging, social networking information delivery means, or any combination thereof.

17. An apparatus, comprising:
a data storage unit that stores user input from a user, data from one or more databases or data sources, financial market-related information from a data mining service, and a user-specific investment strategy that is computed based at least on the user input, a user profile of the user, a trading style of the user, and the financial market-related information; and
a computation unit coupled to the data storage unit, the computation unit configured to:
cause the user-specific investment strategy or financial market data to be displayed;
receive further user input from the user indicative of one or more adjustments to the user-specific investment strategy; and
cause a graphical representation of the further user input to be displayed.

18. The apparatus of claim 17, further comprising:
a financial subscription unit that manages subscription to one or more financial news letters and stock letters, and correlates the one or more financial news letters and stock letters with one or more authors.

19. The apparatus of claim 18, further comprising:
a ranking and statistics unit that computes a respective performance score for each of the authors and ranks the authors according to the respective performance scores.

20. The apparatus of claim 17, further comprising:
a strategy formulation unit that generates one or more investment strategies based at least on the user input, the user profile of the user, the trading style of the user, the data from one or more databases or data sources, and the financial market-related information.
